(19) United States
(12) Patent Application Publication
(10) Pub. No.: US 2005/0019634 A1
(43) Pub. Date: Jan. 27, 2005

(54) Device for extending zinc-air battery life for intermittent use

(76) Inventor: Larry K. Legg, Perry, OH (US)

Correspondence Address: Larry K. Legg, 5325 Blair Road, Perry, OH, 44081, US

(21) Appl. No.: 10/896,658

(22) Filed: Jul. 22, 2004

Related U.S. Application Data
(60) Provisional application No. 60/489,285, filed on Jul. 23, 2003.

(51) Int. Cl. H01M 4/00; H01M 2/08; H01M 4/42; H01M 4/58

(52) U.S. Cl. 429/27; 429/229; 429/35

(57) ABSTRACT

A device for extending zinc-air battery life for intermittent use with a battery chamber that allows air to flow to the batteries when needed, a battery chamber to completely seal off air flow to the batteries when the device is off, a tension device that enables stacking of zinc-air hearing aid batteries without cutting off air flow between the batteries, a battery chamber with minimal air volume.

### CROSS REFERENCE TO RELATED APPLICATIONS

This application is based on provisional application Ser. No. 60/489,285, filed on Jul. 23, 2004.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of portable electronics and more specifically to a device for extending zinc-air battery life for intermittent use. There are many of today's electrical and electronic devices that benefit from small, lighter and more powerful power supplies. This makes them easier to carry, gives them longer usage time and makes them more desirable.

Zinc-air power has been around for many years. Zinc-air batteries are widely used in hearing aids because of their high power to size ratio. They are actually considered miniature environmentally friendly fuel cells.

The problem in the past with using zinc-air batteries in devices that are not being used constantly, such as a hearing aid, is that their power depletes from being exposed to air, even with no load being drawn. This invention overcomes that problem

### BRIEF SUMMARY OF THE INVENTION

The primary object of the invention is to provide a system that utilizes common zinc-air batteries used in hearing aids to power items used intermittently such as a flashlight.

Another object of the invention is to provide a system that enables smaller designs to be implemented by utilizing batteries with the highest power to size ratio.

Another object of the invention is to provide a system that enables lighter items to be designed by utilizing batteries with the highest power to weight ratio.

A further object of the invention is to provide a system that increases the activated life of a zinc-air battery from two months to over one year.

Yet another object of the invention is to provide a system that is air tight and waterproof when switched off.

Still yet another object of the invention is to provide a system that will power devices ten times longer during continuous use than devices using conventional batteries.

Another object of the invention is to provide a system that utilizes batteries that are environmentally friendly.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a device for extending zinc-air battery life for intermittent use comprising: a battery chamber that allows air to flow to the batteries when needed, a battery chamber with a means to completely seal off air flow to the batteries when the device is off, a tension device that enables stacking of zinc-air hearing aid batteries without cutting off air flow between the batteries, a battery chamber with minimal air volume.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a cross sectional view of the invention.

FIG. 2 is a cross sectional view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

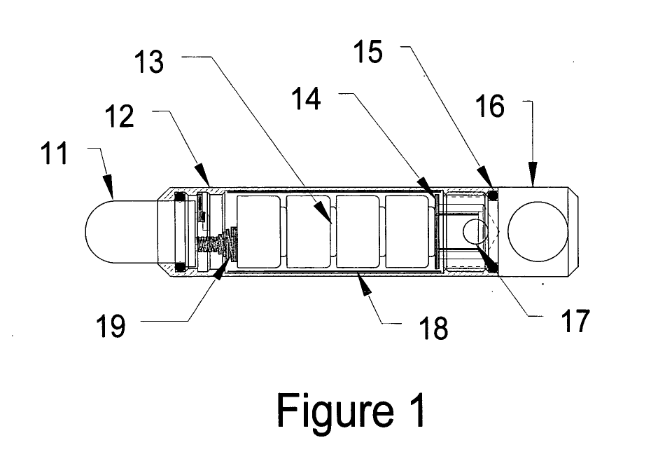

Turning first to FIG. 1 there is shown the invention in the switched off position configured to power a light emitting diode 11 to be used as a flashlight.

In the particular device illustrated four common zinc-air hearing aid batteries 13 are stacked and inserted into the cylindrical body 12. By way of illustration one can view the integral seal and connector in the switched off position. Whereas the seal 15 and the connector 14 are attached in this instance to a moveable unit 16. To further explain the conductive connector 14 in disconnected from the housing 12 being constructed from or having attached to a conductive component. The sealing mechanism 15 is then engaged in the housing 12 creating an air tight seal thusly closing air access to the air orifice 17 and consequently the batteries 13. It is during this stated off position that the feature of the minimal volume battery chamber 18 performs its function. To explain, smaller the amount of residual air the lower the amount of battery degradation during storage.

It is to be noted that the tension device 19 which could be configured on either end of the batteries 13 is not performing its primary function at this point.

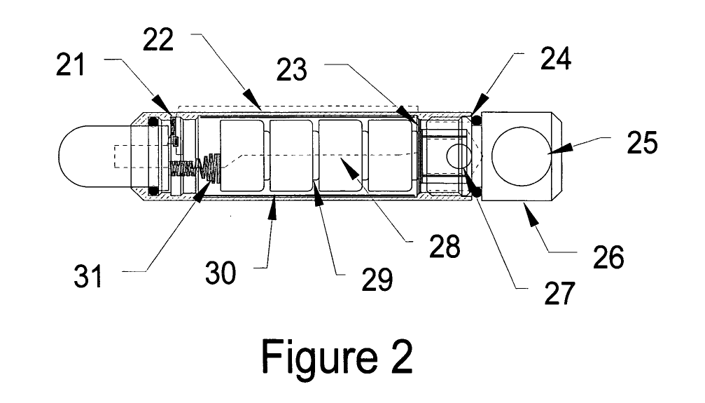

Turning now to FIG. 2 the invention is shown in the switched on position.

As illustrated the connector 23 has made contact with the conductive member, attached to or constructed from housing 22 and is additionally connected to the batteries 29 completing the circuit 28. The moveable unit 26 that has moved connector 23 into the on position has also opened air access to the batteries. Air now flows by the opened seal 24 through the air orifice 27 and into the battery chamber 30. It is now that the tension device 31 performs its primary function. The primary function of the tension device 31 is to hold the stacked batteries 29 together tight enough to make positive contact but not so tight that the air supply cannot enter between the stacked batteries 29. The secondary function of the tension device 31 is to complete the circuit. One of the additional features of the invention is the key ring hole 25.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A device for extending zinc-air battery life for intermittent use comprising:
a battery chamber that allows air to flow to the batteries when needed;
a battery chamber with a means to completely seal off air flow to the batteries when the device is off;
a tension device that enables stacking of zinc-air hearing aid batteries without cutting off air flow between the batteries;
a battery chamber with minimal air volume.
